(19) United States
(12) Patent Application Publication
(10) Pub. No.: US 2020/0048952 A1
(43) Pub. Date: Feb. 13, 2020

(54) SYSTEMS AND METHODS FOR PREVENTING THEFT OF VALUABLES FROM PROTECTED COMPARTMENTS

(71) Applicant: CEEBright, LLC, Hallandale, FL (US)

(72) Inventors: Lawrence Kronick, Hollywood, FL (US); Eduardo Capraroli, Miami, FL (US)

(21) Appl. No.: 16/534,795

(22) Filed: Aug. 7, 2019

Related U.S. Application Data
(60) Provisional application No. 62/715,418, filed on Aug. 7, 2018.

(51) Int. Cl. E05G 1/14; B60P 3/03; G06K 9/00

(52) U.S. Cl. CPC E05G 1/14; G06K 9/00791; B60P 3/03

(57) ABSTRACT

A theft prevention system is capable of filling an interior of a protected compartment (e.g., an armored vehicle, a vault, a safe, etc.) to prevent access to the interior of the protected compartment and/or to encapsulate contents of the protected compartment upon detection of a threat. Such a theft prevention system may include a threat detection element capable of monitoring an area within which the protected compartment is located for indicators of a threat to the vault and/or its contents (e.g., audible signals, visual signals, physical actions, etc.). Upon detecting a probable threat, the threat detection element may cause an encapsulant dispersal system to introduce an expandable encapsulating material into the interior of the protected compartment to prevent limit to the interior of the protected compartment and/or to prevent contents of the interior of the protected compartment from being removed therefrom. Theft prevention methods are also disclosed.

### CROSS-REFERENCE TO RELATED APPLICATION

A claim for the benefit of priority to the Aug. 7, 2018 filing date of U.S. Provisional Patent Application No. 62/715,418, titled SYSTEMS AND METHODS FOR PREVENTING THEFT OF VALUABLES FROM PROTECTED COMPARTMENTS (“the '418 Provisional application”) is hereby made pursuant to 35 U.S.C. § 119(e). The entire disclosure of the '418 Provisional application is hereby incorporated herein.

### TECHNICAL FIELD

This disclosure relates generally to theft prevention systems and methods and, more specifically, to systems and methods for securing the contents of protected compartments, such as armored vehicles, safes, vaults, and the like. More specifically, this disclosure relates to theft prevention systems that, upon detection of a probable threat, are capable of filling an interior of a protected compartment with an expandable encapsulating material that prevents access to the interior of the protected compartment and/or encapsulates contents of the protected compartment.

### SUMMARY

A theft prevention system according to this disclosure is capable of supplementing the security that is already provided by a protected compartment. The theft prevention system may further limit access to valuable items within an interior of the protected compartment. Access to the valuable items within the interior of the protected compartment may be further limited by way of an encapsulant dispersal element. The encapsulant dispersal element may be capable of quickly introducing an expandable encapsulating material into the interior of the protected compartment. The expandable encapsulating material may comprise a material that is capable of quickly expanding (e.g., foaming, etc.) and hardening (e.g., polymerizing, etc.). The encapsulant dispersal element may direct the expandable encapsulating material to selected locations within the interior of the protected compartment (e.g., onto one or more access points to the interior of the protected compartment, onto contents within the interior of the protected compartment, etc.). Alternatively, the encapsulant dispersal element may direct the expandable encapsulating material substantially throughout an entirety of the interior of the protected compartment. In some embodiments, the encapsulant dispersal element may be capable of dispersing the expandable encapsulating material and the expandable encapsulating material may be capable of expanding and hardening in about five seconds or less to quickly limit access to the interior of the sealed container and/or to prevent removal of the contents of the sealed container within the interior of the sealed container.

Operation of the encapsulant dispersal element may be actuated by an individual observing a threat or automatically, in response to a probable threat. Automatic actuation of the encapsulant dispersal element may be enabled by a threat detection element of the theft prevention system. A threat detection element may comprise artificial intelligence (AI) capable of monitoring an area, or environment, within which the protected compartment is located and of identifying potentially threatening activities. The threat detection element may also be capable of assessing a threat level based on the potentially threatening activities it detects and, if the threat level meets or exceeds a predetermined threshold threat level, of actuating the encapsulant dispersal element. In various embodiments, the threat detection element may include one or more monitoring elements and a processing element. The one or more monitoring elements may include monitoring elements that detect movement of the protected compartment (e.g., motion sensors, etc.), sensors that detect impacts on the protected compartment (e.g., impact sensors, etc.), proximity sensors, microphones, cameras, and the like. The one or more monitoring elements may monitor traffic patterns (e.g., traffic in the immediate vicinity of the protected compartment, broader traffic patterns, compare current traffic patterns with normal traffic patterns, etc.), wireless communications, communications made over the internet, and the like. The one or more monitoring elements may convey signals, which carry data, to the processing element (e.g., a computer processor, a microcontroller, etc.). The monitoring element(s) may convey signals intermittently (e.g., when the threat detection element operates on stored power, etc.) or continuously. The processing element, operating under control of suitable programming, may process the data received from the monitoring element(s) to determine a current threat level and to determine whether the current level meets or exceeds the predetermined threshold threat level. In the event that the threat level meets or exceeds the predetermined threshold threat level, the processing element may designate that threat level as a probable threat to the contents of the protected compartment and may actuate the encapsulant dispersal element of the threat prevention system.

The theft prevention system may be equipped to prevent actuation of the encapsulant dispersal element while a protected compartment (e.g., a vault, etc.) is occupied by an individual. More specifically, while one or more monitoring elements (e.g., a camera, a thermal sensor, etc.) and the processing element (e.g., an image analytics algorithm, etc.) of a threat detection element of the theft prevention system indicate that an individual is present in the protected compartment or that introduction of the encapsulant into the protected compartment may otherwise be undesirable, programming of the processing element of the threat detection element may prevent the threat detection element from actuating the encapsulant dispersal element. Thus, the theft prevention system may be programmed to prevent injury or death. In some such embodiments, the theft prevention system may provide a warning and a manual override option, which may enable an individual to assess the situation and actuate the encapsulant dispersal element.

The theft prevention system may be self-sustained and remotely actionable with bidirectional communications and embedded intelligence.

In another aspect, methods for supplementing the security provided by a protected compartment are disclosed. Such a method includes evaluating potential threats to the contents of the protected compartment. Evaluation of the potential threats to the contents of the protected compartment may be conducted intermittently or continuously. The potential threats to the contents of the protected compartment may be evaluated by an individual (i.e., manually) or automatically (e.g., by AI, etc.). In the event that evaluation of potential threats leads to identification of a probable threat to the contents of the protected compartment, an expandable encapsulating material may be introduced into an interior of the protected compartment. The expandable encapsulating material may be directed toward access points to the interior of the protected compartment. Alternatively, the expandable encapsulating material may be directed toward contents of the interior of the protected compartment. As another alternative, the expandable encapsulating material may be introduced throughout the interior of the protected compartment (e.g., throughout substantially an entirety of the interior of the protected compartment, throughout an entirety of the interior of the protected compartment, etc.). As the expandable material is introduced into the interior of the protected compartment, it may expand (e.g., foam, etc.) and harden (e.g., polymerize, etc.). Introduction of the expandable encapsulating material into the interior of the protected compartment and hardening of the expanded encapsulating material may occur in as quickly as five seconds. In some embodiments, the expandable encapsulating material may be introduced into the interior of the protected compartment, expand, and harden in five seconds or less. Once there is no longer a threat to the contents of the protected compartment, the expanded encapsulating material may be removed from those contents—a process which may take a significant amount of time.

Other aspects of the disclosed subject matter, as well as features and advantages of various aspects of the disclosed subject matter, will become apparent to those of ordinary skill in the art through consideration of the ensuing description, the accompanying drawings, and the appended claims.

### BRIEF DESCRIPTION OF THE DRAWINGS

In the drawings:

FIG. 1 provides a schematic representation of an embodiment of a theft prevention system according to this disclosure, which embodiment includes an encapsulant dispersal element and a threat detection element;

FIG. 2 illustrates an embodiment of an encapsulant dispersal element that may be used in the embodiment of theft prevention system shown in FIG. 1;

FIG. 3 depicts an embodiment of an encapsulant delivery device of the encapsulant dispersal element shown in FIG. 2;

FIG. 3A is an exploded view of the encapsulant delivery device shown in FIG. 3;

FIG. 3B is an assembled representation of the encapsulant delivery device shown in FIG. 3; and

FIG. 4 is a schematic representation of a threat detection element of the embodiment of theft prevention system shown in FIG. 1.

### DETAILED DESCRIPTION

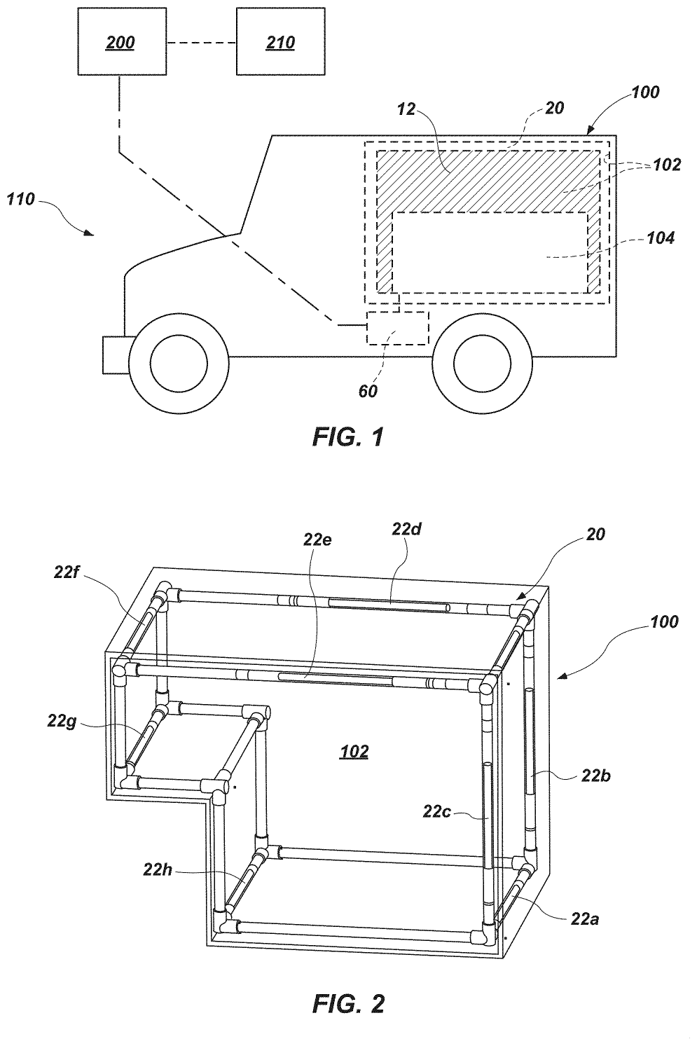

Referring to FIG. 1, an embodiment of a theft prevention system 10 is illustrated. The theft prevention system 10 may be used with a protected compartment 100, such as a protected compartment 100 of an armored vehicle 110, a vault, a safe, or the like. The theft prevention system 10 includes an encapsulant dispersal element 20. The encapsulant dispersal element 20 is capable of delivering an expandable encapsulating material 12 into an interior 102 of the protected compartment 100. Thus, the encapsulant dispersal element 20 may communicate with the interior 102 of the protected compartment 100. In some embodiments, the encapsulant dispersal element 20 may be located within the interior 102 of the protected compartment 100.

In addition to the encapsulant dispersal element 20, a theft prevention system 10 according to this disclosure may include a threat detection element 60. The threat detection element 60 may be capable of monitoring the protected compartment 100 and/or an area, or an environment, within which the protected compartment 100 is located. The threat detection element 60 may have a configuration that enables it to monitor, sense, or detect one or more types of activities that may be indicative of a threat to the protected compartment 100 and its contents 104 (e.g., valuables, etc.), which activities are also referred to herein as “threat indicators.” In addition, the threat detection element 60 (e.g., an AI of the threat detection element 60, etc.) may evaluate one or more threat indicators using a set of threat detection rules to determine a likelihood that an individual or a group of individuals will try to break into, or breach, the protected compartment 100. That likelihood may also be referred to as a “threat level.” If the threat level reaches or exceeds a predetermined threshold, as determined by the set of threat detection rules, the threat detection element 60 may designate a threat indicator or a collection of threat designators as a “probable threat.”

In some circumstances, regardless of the threat level, the threat detection element 60 may be programmed to prevent actuation of the encapsulant dispersal element 20 and, thus, the introduction of an encapsulant into the protected compartment 100. As an example, if the threat detection element 60 determines that the protected compartment 100 (e.g., a large protected compartment, such as a vault, etc.) is occupied by an individual, a processing element of the threat detection element 60 may prevent the threat detection element 60 from actuating the encapsulant dispersal element 20. Thus, the theft prevention system 10 may be programmed to automatically override protection of the protected compartment 100 in events where the consequences of protection outweigh the benefits of protection (e.g., to prevent injury or death, etc.). In some such embodiments, when the threat detection element 60 determines that the threat level otherwise warrants actuation of the encapsulant dispersal element 20, the theft prevention element 60 may provide a warning and a manual override option, which may enable an individual to assess the situation and, if the individual deems it appropriate, actuate the encapsulant dispersal element 20.

When a probable threat exists, the threat detection element 60 may actuate the encapsulant dispersal element 20, causing it to introduce the expandable encapsulating material 12 into the interior 102 of the protected compartment 100.

Turning now to FIG. 2, a specific, but nonlimiting embodiment of an encapsulant dispersal element 20 is depicted in connection with a protected compartment 100 that comprises an armored vehicle 110 (FIG. 1). In the depicted embodiment, the encapsulant dispersal element 20 is located within the interior 102 of the protected compartment 100. The encapsulant dispersal element 20 may be arranged and/or oriented in a manner that enables it to direct the expandable encapsulating material 12 (FIG. 1) toward one or more selected locations within the interior 102 of the protected compartment 100. While the encapsulant dispersal element 20 may be arranged and/or oriented in a manner that directs the expandable encapsulating material 12 toward one or more access points to the interior 102 of the protected compartment 100 (e.g., locations where the interior 102 may be accessed, such as doors, etc.), the arrangement and orientation depicted by FIG. 2 enables the encapsulant dispersal element 20 to distribute the expandable encapsulating material 12 throughout substantially an entirety or the interior 102 or even throughout the entire interior 102. More particularly, the encapsulant dispersal element 20 may be arranged and oriented to distribute the expandable encapsulating material throughout voids or cavities in the interior 102 of the protected compartment 100 that are not occupied by valuables or other items. As FIG. 2 shows, the encapsulant dispersal element 20 may include a plurality of segments 22a, 22b, 22c, etc. (individually and collectively, segments 22), that may be located in corners between adjacent pairs of panels that define the walls of the interior 102. The segments 22a, 22b, 22c, etc., may be associated with one another (e.g., physically and/or electronically joined to one another, etc.) in a manner that enables simultaneous operation all of the segments 22a, 22b, 22c, etc. Each segment 22 may include a tube or another enclosure 24 that carries a delivery device 30.

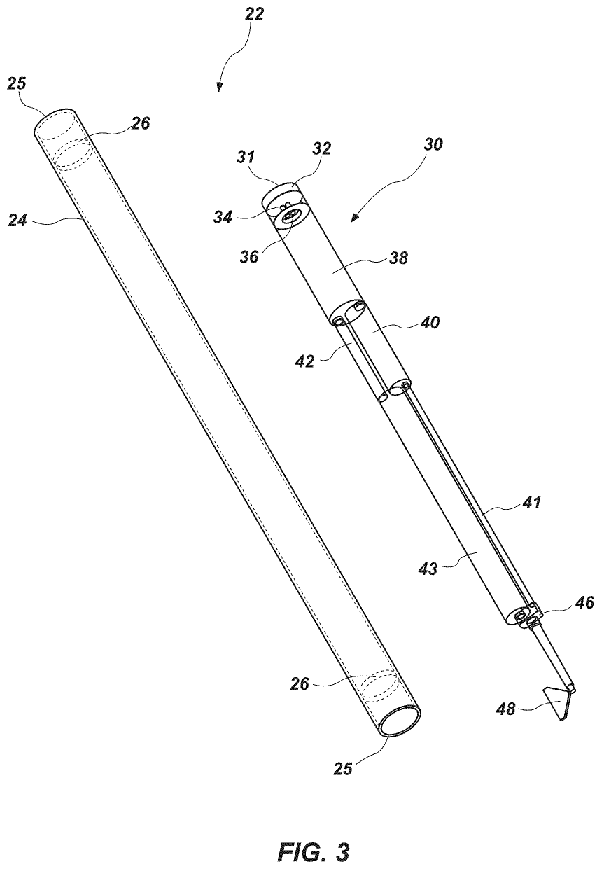

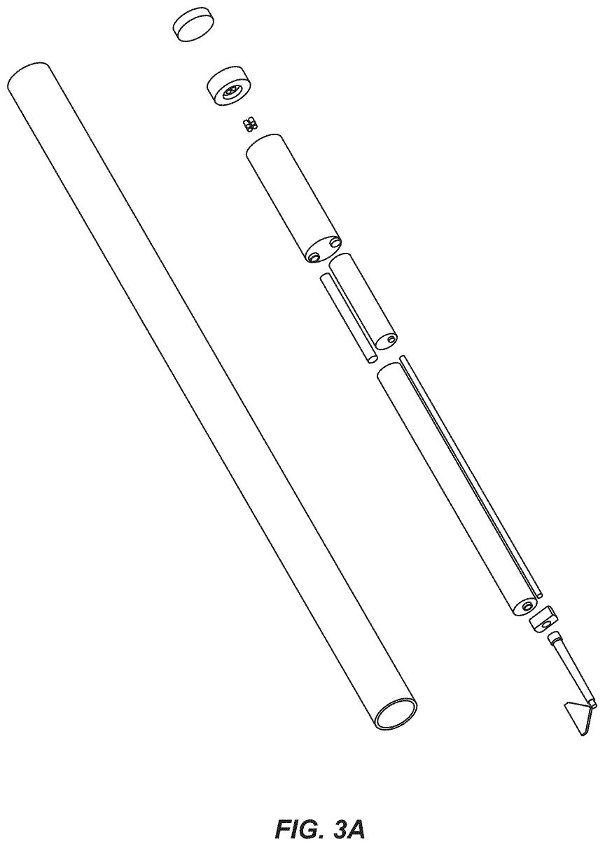

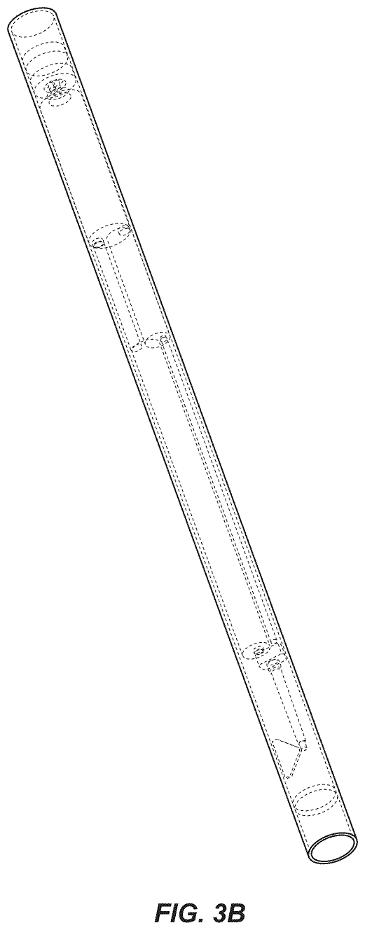

FIG. 3 illustrates each segment 22 of the embodiment of encapsulant dispersal element 20 shown in FIG. 2 in further detail. The enclosure 24 of each segment 22 may comprise a length of a tube or a pipe. In the specific embodiment illustrated by FIG. 2, the enclosure 24 comprises a length of 2 inch diameter PVC (polyvinyl chloride) pipe. The delivery device 30 of the segment 22 may be received within an interior of the enclosure 24 of the segment 22 and held in place by tamps 26 at or near ends 25 of the enclosure 24.

The delivery device 30 may have a configuration (e.g., a wireless communication element, a wired communication port, etc.) that enables a switch, a controller, or a processor of the delivery device 30 to receive and optionally process data from a manual trigger or from the threat detection element 60 (FIG. 1). In some embodiments, the delivery device 30 may be capable of communicating data to a threat detection element 60.

At one end 31, the delivery device 30 includes a trigger circuit 32, which may be actuated manually or under control of the threat detection element 60 (FIG. 1). In some embodiments, a signal (e.g., using a random double security key, etc., to verify that the origin of the signal and the authorization are valid) may actuate the trigger circuit 32.

The trigger circuit 32 may communicate with one or more igniters 34. Each igniter 34 may release a high current discharge. The high current discharge of each igniter 34 may be communicated to an ignition chamber 36 that carries an accelerant. The ignition chamber 36 may communicate with a pressure chamber 38, which may be pressurized upon ignition of the accelerant within the ignition chamber 36. In a specific embodiment, ignition of the accelerant may generate about 5 psi of a non-toxic gas in the pressure chamber 38. In turn, the pressure chamber 38 may communicate with canisters 40 and 42. The canisters 40 and 42 may contain separate parts of the expandable encapsulating material 12 (FIG. 1). In a specific embodiment, canister 40 may contain 480 ml of isocyanate and canister 42 may contain 66 ml of dichloromethane and glycol in equal parts. A sudden increase of the pressure within the pressure chamber 38 may be communicated to the canisters 40 and 42. Substantially the same amount of pressure or the same amount of pressure may be applied to, or exerted on, both canisters 40 and 42. The application of pressure to the canisters 40 and 42 may break a membrane (e.g., a crystal membrane, such as a glycol silicate membrane, etc.) that holds the material within each canister 40, 42. The pressure may also force the materials stored within the canisters 40 and 42 through corresponding conduits 41 and 43, respectively. Both conduits 41 and 43 may lead to a mixing chamber 46, where the separate parts of the expandable encapsulating material 12 (FIG. 1) may be combined and discharged, still under pressure, through a nozzle 48. Further mixing of the separate parts of the expandable encapsulating material 12 may occur as the separate parts travel through the nozzle 48, from which they may be discharged out of an opening in the enclosure 24 and into the interior 102 (FIGS. 1 and 2) of a protected compartment 100 (FIGS. 1 and 2). In some embodiments, the expandable encapsulating material 12 formed by mixing the two parts may be discharged from the nozzle 48 as an aerosol. The delivery device 30 may have a configuration that enables it to eject the expandable encapsulating material 12 in half a second or less.

Once ejected from the nozzle 48 of the delivery device 30, the expandable encapsulating material 12 may expand and harden. In some embodiments, the volume of the expandable encapsulating material 12 may increase (e.g., by about ten (10) times, by about twenty (20) times, by about thirty (30) times, by about forty (40) times, etc.). The expandable encapsulating material 12 may harden (e.g., polymerize, etc.) in about five seconds or less. Once encapsulated and hardened, the expanded encapsulating material (not shown) may form a solid mass. The encapsulating material 12 may be directed to one or more selected locations within the interior 102 of the protected compartment 100 (e.g., toward access points to the interior 102 of the protected compartment 100, onto the contents 104 of the protected compartment 100, etc.), resulting in the formation of a solid mass at each such location. Alternatively, the encapsulating material 12 may be directed throughout the interior 102 of the protected compartment 100, into voids or cavities in the interior 102 of the protected compartment 100, and surrounding any contents 104 (e.g., valuables, etc.) within the interior 102 of the protected compartment 100, thereby preventing removal of the contents 104 from the interior 102 of the protected compartment 100.

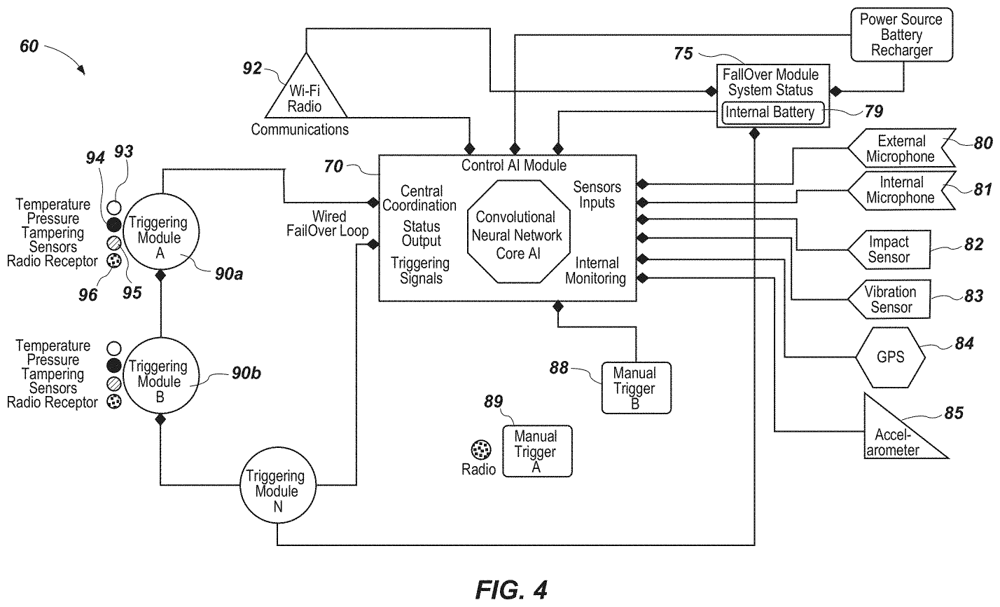

With reference to FIG. 4, an embodiment of a threat detection element 60 is depicted. The threat detection element 60 may include a command module 70, a failover module 75, and one or more monitoring elements 80-85. In addition, the threat detection element 60 may include other components, such as a manual trigger (a local manual trigger 88, a remote manual trigger 89, etc.), one or more triggering modules 90, and a wireless communication element 92.

The command module 70, which may also be referred to as a “processing element” of the threat detection element 60, may comprise a self-sustained operational computing unit. Among other things, the command module 70 may include a central processing unit (CPU), a video processing unit (VPU), memory, and one or more communications buses. The CPU and/or VPU of the command module 70 may execute one or more programs that enable threat detection, evaluation of delivery devices 30 (FIG. 3) of the encapsulant dispersal element 20 (FIGS. 1-3), and operation of the delivery devices 30.

The failover module 75 comprises a standby for the command module 70 to protect the threat detection element 60 from failure. Thus, the failover module 75 may also serve as a processing element, and may also comprise a self-sustained operation computing unit. The failover module 75 may include a CPU, memory, and at least one communication bus, as well as a battery 79. The CPU of the failover module 75 may execute one or more programs that enable threat detection, evaluation of delivery devices 30 of the encapsulant dispersal element 20 (FIGS. 1-3), and operation of the delivery devices 30 (FIG. 3).

A variety of different monitoring elements 80-85 may communicate with the command module 70 and the failover module 75. As an example, the threat detection element 60 may include an external microphone 80, an internal microphone 81, an impact sensor 82, a vibration sensor 83, a GPS (Global Positioning System) module 84, and an accelerometer 85. Other examples of monitoring elements that may be used with a threat detection element 60 include door state sensors, cameras, temperature sensors, pressure sensors, tampering sensors, radio receivers (e.g., a sub-1 GHz radio module, etc.), and the like.

The threat detection element 60 or, rather, its command module 70 and/or failover module 75, may execute one or more applications, or programs, that enable it to identify a possible threat, determine a likelihood that the possible threat will result in an actual threat, designate such a possible threat as a “probable threat,” and actuate the encapsulant dispersal element 20 (FIG. 3).

In some embodiments, the applications executed by the threat detection element 60 or, more specifically, by its command module 70 and failover module 75 may comprise artificial intelligence software and supporting hardware that may comprise a neural network module. The neural network module may enable the threat detection element 60 to continuously learn one or more sets of threat detection rules and improve the decision making ability of the threat detection element 60 over time to progressively optimize when to best trigger the encapsulant dispersal element 20 (FIG. 3). Initially, a so-called “training set” of information may be used to establish a central knowledge database 210 of various criteria used in setting the threat detection rules. Without limitation, the training set of information may include ballistic sounds, urban environment noise, and human commands. The threat detection element 60 may “learn” continuously as new data from the environment within which the threat detection element 60 is located is gathered and processed. The threat detection element 60 may compare new data with a central knowledge database 210 in order to evaluate and improve the automatic decision making process used to decide whether to trigger the encapsulant dispersal element 20. The central knowledge database 210 may be located remotely from a remainder of the threat detection element 60 (e.g., it may be cloud based, associated with a central event server 200, etc.), and need not be online for the threat detection element 60 to function properly.

The threat detection element 60 may also include a triggering module 90a, 90b, etc., for each segment 22a, 22b, etc. (FIG. 2), respectively, of the encapsulant dispersal element 20 (FIG. 2). Each triggering module 90a, 90b, etc., may communicate with the trigger circuit 32 (FIG. 3) of its corresponding segment 22 to enable that segment 22 to be actuated by the command module 70 and/or the failover module 75 of the threat detection element 60.

In addition to detecting threats to the protected compartment 100 and its contents 104, the command module 70 of the threat detection element 60 may monitor the encapsulant dispersal element 20 (FIGS. 1-3) and/or components of the encapsulant dispersal element 20. More specifically, the command module 70 may monitor one or more monitoring elements (e.g., pressure sensors 93, temperature sensors 94, tamper sensors 95, etc.) and a radio 96 associated with one or more segments 22 (FIGS. 2 and 3) (e.g., each segment 22, etc.) of the encapsulant dispersal system 20, as well as a wiring status of the encapsulant dispersal system 20. Such monitoring may enable the command module 70 to determine whether or not the encapsulant dispersal system 20 is functioning properly, make any adjustments to the encapsulant dispersal system 20 (e.g., activation of a heating element to ensure that a temperature of the nozzle 48 (FIG. 3) is maintained within an operative temperature range, etc.), determine whether or not any maintenance is needed, and report any abnormalities to appropriate security personnel. The command module 70 may monitor the encapsulant dispersal element 20 and/or its components when few, if any, indicators of a threat are detected (e.g., prior to transporting the protected compartment 100 and/or its contents 104, when threat monitoring indicates that no threats are present, etc.), or during “idle time.” Alternatively, the command module 70 may monitor the encapsulant dispersal element 20 or various components of the encapsulant dispersal element 20 while the command module 70 monitors for threats to the protected compartment 100 and its contents 104.

The command module 70 and/or the failover module 75, which may operate in isolation from one another, may also monitor a state of the other module (i.e., the command module 70 may monitor the failover module 75 and the failover module 75 may monitor the command module 70) to determine whether or not the other module is functioning normally or abnormally. If any abnormal situation is detected (e.g., tampering, malfunction, etc., of hardware or software) a malfunction alert may be generated so that the problem may be properly addressed.

With continued reference to FIGS. 1-4, in a specific but non-limiting embodiment of use, a theft prevention system 10 may be used to protect the contents 104 of a protected compartment 100 of an armored vehicle 110. The encapsulant dispersal element 20 may have a configuration that enables it to be positioned within corners of the protected compartment 100 in a manner that minimizes the amount of space the encapsulant dispersal element 20 occupies within the protected compartment 100, while enabling the encapsulant dispersal element 20 to direct the encapsulant 12 onto the contents 104 of the protected compartment 100.

Prior to transporting the protected compartment 100 and any valuable items therein, the command module 70 of the threat detection element 60 may be activated. Activation of the command module 70 may include connection of the command module 70 to a central event server 200, which may transmit an up-to-date version of the applicable threat detection rules to the command module 70 and, optionally, to the failover module 75. The threat detection element 60, including its command module 70 and failover module 75, may then be activated. In addition, the threat detection element 60 may provide an indicator of when the threat detection element 60 has been activated, which may include enabling operation of the armored vehicle 110.

Prior to and/or while transporting the protected compartment 100, the command module 70 may monitor the encapsulant dispersal element 20 and/or components of the encapsulant dispersal element 20 (e.g., segments 22 thereof, etc.) to ensure that the encapsulant dispersal element 20 and/or its components are functioning as intended. Monitoring of the encapsulant dispersal element 20 and/or its components may continue periodically or intermittently during transportation of the armored vehicle 110 and its protected compartment 100.

As the armored vehicle 110 transports the protected compartment 100 and its contents 104, the threat detection element 60 may monitor various sounds (e.g., sounds detected by the external microphone 90 and/or the internal microphone 91). The threat detection element 60 may monitor data regarding the route traveled by the armored vehicle 110, the location of the armored vehicle 110 (e.g., by way of the GPS module 94), and/or data obtained from various other monitoring elements of the threat detection element 60 (e.g., door state sensors, vibration sensors 93, impact sensors 92, etc.). The threat detection element 60 may also be capable of detecting any manual directives received from a local manual trigger 88 and/or a remote manual trigger 89. Such information may provide the command module 70 and/or the failover module 75 with data that will enable a determination by the artificial intelligence, as it applies the threat detection rules, of whether or not there is a probable threat to the contents 104 of the protected compartment 100. If the command module 70 and/or the failover module 75 of the threat detection element 60 determines that there is a probable threat to the protected compartment 100 and its contents 104, the command module 70 and/or the failover module 75 may send a signal (e.g., an encrypted signal, etc.) to the encapsulant dispersal element 20 to actuate the encapsulant dispersal element 20.

Once the armored vehicle 110 and its protected compartment 100 are back at the base station, the command module 70 may upload the data obtained from its monitoring, along with any corresponding information pertinent to actual threats to the protected compartment 100 and its contents 104, to the central knowledge database 210 (e.g., through the central event server 200, etc.). That data and information may be used to update the central knowledge database 210 for use in connection with future uses of the armored vehicle 110 or other armored vehicles (e.g., in the same fleet, in the same area, etc.).

Although the foregoing description sets forth many specifics, these should not be construed as limiting the scope of any of the claims, but merely as providing illustrations of some embodiments and variations of elements or features of the disclosed subject matter. Other embodiments of the disclosed subject matter may be devised which do not depart from the spirit or scope of any of the claims. Features from different embodiments may be employed in combination. Accordingly, the scope of each claim is limited only by its plain language and the legal equivalents thereto.

What is claimed:

1. A theft prevention system, comprising;
a protected compartment including an interior capable of securing one or more valuable items;
a threat detection element associated with the protected compartment, the threat detection element capable of monitoring the protected compartment and/or an area within which the protected compartment is located to identify a likely threat against the protected compartment and/or contents of the protected compartment;
an encapsulant dispersal element in communication with the threat detection element and capable of dispersing an expandable encapsulating material into the interior of the protected compartment upon actuation by the threat detection element; and
the expandable encapsulating material capable of restricting access to the interior of the protected compartment and/or preventing removal of the contents from the interior of the protected compartment.

2. The theft prevention system of claim 1, wherein the protected compartment is an armored vehicle.

3. The theft prevention system of claim 2, wherein the threat detection element is capable of monitoring an environment in which the armored vehicle is located.

4. The theft prevention system of claim 3, wherein the threat detection element is capable of monitoring the environment in which the armored vehicle is located for audible indicators of a threat against the protected compartment and/or the contents of the protected compartment.

5. The theft prevention system of claim 3, wherein the threat detection element is capable of monitoring the environment in which the armored vehicle is located for visible indicators of a threat against the protected compartment and/or the contents of the protected compartment.

6. The theft prevention system of claim 3, wherein the threat detection element is capable of determining a likelihood that the protected compartment and/or the contents of the protected compartment are threatened and, in the event that the likelihood exceeds a predetermined threshold, of actuating the encapsulant dispersal system.

7. The theft prevention system of claim 2, wherein the threat detection element is capable of monitoring operation and/or movement of the armored vehicle.

8. The theft prevention system of claim 1, wherein the encapsulant dispersal element is capable of delivering the expandable encapsulating material over access points to the interior of the protected compartment.

9. The theft prevention system of claim 1, wherein the encapsulant dispersal element is capable of delivering the expandable encapsulating material throughout substantially an entirety of the interior of the protected compartment.

10. The theft prevention system of claim 1, wherein the encapsulant dispersal element is capable of completely delivering the expandable encapsulating material in five seconds or less.

11. The theft prevention system of claim 10, wherein the expandable encapsulating material is capable of expanding and substantially hardening in five seconds or less.

12. The theft prevention system of claim 1, wherein the expandable encapsulating material comprises a foaming polymer.

13. The theft prevention system of claim 1, wherein the expandable encapsulating material is capable of removal from the interior of the protected compartment and/or the contents of the interior of the protected compartment.

14. A method for preventing theft of contents of a protected compartment, comprising:
monitoring the protected compartment and/or an area in which the protected compartment is located;
determining a threat level based on the monitoring;
determining whether the threat level meets or exceeds a threshold threat level;
in the event that the threat level meets or exceeds the threshold threat level, introducing an expandable encapsulating material into the interior of the protected compartment; and
enabling the expandable encapsulating material that has been introduced into the interior of the protected compartment to expand and to harden to limit access to the interior of the protected compartment and/or to encapsulate the contents within the interior of the protected compartment.

15. The method of claim 14, wherein monitoring comprises monitoring an environment within which an armored vehicle that comprises the protected compartment is located.

16. The method of claim 15, wherein monitoring comprises monitoring the environment for at least one of audible signals of a threat and visible signals of a threat.

17. The method of claim 14, wherein monitoring, determining the threat level and determining whether the threat level meets or exceeds a threshold threat level comprise continuously monitoring the protected compartment and/or an area in which the protected compartment is located, continuously determining the threat level based on the continuously monitoring, and continuously determining whether the threat level meets or exceeds the threshold threat level.

18. The method of claim 14, wherein introducing includes directing the expandable encapsulating material toward access points to the protected compartment.

19. The method of claim 14, wherein introducing and enabling comprise substantially filling the interior off the protected compartment with expanded encapsulating.

20. The method of claim 14, wherein introducing the expandable encapsulating material into the interior of the protected compartment occurs in about five seconds or less.

21. The method of claim 20, wherein enabling the expandable encapsulating material that has been introduced into the interior of the protected compartment to expand and harden also occurs in about five seconds or less.

22. The method of claim 14, further comprising:
removing the encapsulant from the interior of the protected compartment and/or the contents of the protected compartment after a threat has been eliminated.
